(19) United States
(12) Patent Application Publication
(10) Pub. No.: US 2008/0303478 A1
(43) Pub. Date: Dec. 11, 2008

(54) Integrated home appliance

(76) Inventors: Kuan-Wei Lee, Taipei City (TW); Shun-Yung Chang, Taipei City (TW); Shih-Hua Chang, Taipei City (TW); Sung-Kai Chen, Taipei City (TW); De-Ming Wang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/153,904

(22) Filed: May 28, 2008

(30) Foreign Application Priority Data
Jun. 8, 2007 (TW) 96209484

(51) Int. Cl. H02J 7/00

(52) U.S. Cl. 320/101; 320/127

(57) ABSTRACT

An integrated home appliance includes a base, a home appliance, and a solar panel. The base includes a secondary battery, and a first port. The appliance has a second port. The solar panel has a third port corresponding to first port. The application device and the solar panel are alternately connected to the base. When the solar panel is connected to the base, the solar panel converts solar energy to power, and the power recharges the secondary battery. When the home appliance is connected to the base, the home appliance receives power from the secondary battery. Therefore, the home appliance does not need an electrical cord to receive power.

### BACKGROUND OF THE INVENTION

1. Field of the Invention

The present invention relates to an integrated home appliance and in particular to an integrated home appliance that combines with an independent home appliance and a power supply.

2. Description of Related Art

All kinds of electronic devices of 3C (computer, communication and consumer) have developed rapidly in recent years, and the requirements of such consumer products have also increased. However, in the design of traditional home appliances every product has electrical cord connecting to the utility power supply for getting power. If a consumer has many kinds of home appliances, the consumer will have trouble in putting the electrical cords in order and the appearance of the room in which the products are stored or used will become cluttered and messy.

Moreover, because the conception of environmental protection has also improved, manufacturers need to develop products that need less energy to operate or use renewable energy resources, thereby reducing the burden on power supply and improving the quality of the environmental protection. Besides, a new developed energy source should be produced on a mass level and can not pollute the environment. Therefore, solar energy is increasingly viewed as the first choice as a renewable energy resource that can be produced on a mass scale.

In conclusion, home appliances with the advantages of simpler design, lower cost, less energy use, and which do not contribute to environmental damage or waste are worthy of much further research.

### SUMMARY OF THE INVENTION

It is an object of the present invention to provide a home appliance that does not need an electrical cord, and in which the appliance gets the electrical power supply from a port connecting to a battery. The battery does not need an electrical cord, and the battery is recharged from a solar panel. The electrical cord of the traditional home appliance is no longer required, and the appearance of the device is cleaner and simpler. Furthermore, storing electrical power or supplying electrical power to the home appliance is based upon solar energy. Less environmental damage is caused.

To achieve the above object, the present invention provides an integrated home appliance, comprising: a base that further includes a secondary battery used for storing an electrical power and generating a direct-current voltage; a first port connected to the secondary battery for transferring the direct-current voltage; and a home appliance that includes a second port which corresponds to the first port for the home appliance connected to the base for receiving the direct-current voltage.

To achieve the above object, the present invention also provides an integrated home appliance, comprising: a base that further comprises a solar panel disposed on the surface of the base for receiving solar energy and transforming it to an electrical power; a secondary battery used for storing the electrical power and generating a direct-current voltage; a first port connected to the secondary battery to transfer the direct-current voltage; and a home appliance including a second port corresponding to the first port for the home appliance connected to the base for receiving the direct-current voltage.

### BRIEF DESCRIPTION OF THE DRAWINGS

The present invention can be fully understood from the following detailed description and preferred embodiments with reference to the accompanying drawings, in which:

FIG. 1 is a function block diagram of the first embodiment of the integrated home appliance according to the present invention;

FIG. 2 is a function block diagram of the second embodiment of the integrated home appliance according to the present invention;

FIG. 3A is a schematic diagram of the application of the first embodiment according to the present invention;

FIG. 3B is a schematic diagram of the application of the first embodiment according to the present invention, wherein the secondary battery is recharged via the solar panel; and

FIG. 4 is a schematic diagram of the application of the second embodiment according to the present invention.

### DETAILED DESCRIPTION OF THE PREFERRED EMBODIMENTS

The following detailed description is of the best presently contemplated modes of applying the invention. This description is not intended to be taken in a limiting sense, but is made merely for the purpose of illustrating general principles of embodiments of the invention. The scope of the invention is best defined by the appended claims.

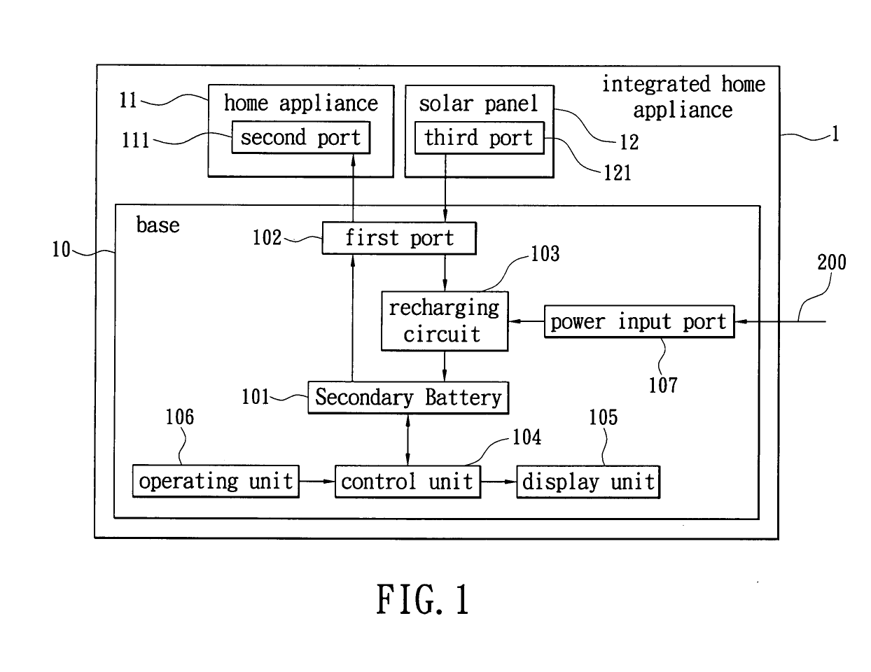

Please refer to FIG. 1, which shows the function block diagram of the first embodiment of the integrated home appliance of the present invention. The integrated home appliance 1 includes a base 10, a home appliance 11, and a solar panel 12. The base 10 includes a secondary battery 101, a first port 102, a recharging circuit 103, a control unit 104, a display unit 105, and an operating unit 106. The secondary battery 101 is used for storing an electrical power and generating a direct-current voltage. Therefore, the secondary battery 101 supplies an electrical power for the integrated home appliance 1 of the present invention. The first port 102 electrically connects to the secondary battery 101. The first port 102 is disposed and protrudes from the surface of the base 10 to transfer the direct-current voltage.

The home appliance 11 and the solar panel 12 are alternately and detachably plugged into the base 10. Therefore, the home appliance 11 includes a second port 111 used for connecting to the first port 102 and the solar panel 12 includes a third port 121 used for connecting to the first port 102. The second port 111 and third port 121 can have the same design.

In the present invention, the home appliance 11 is not designed to connect via an electrical cord. The home appliance 11 is connected to the first port 102 of the base 10 via the second port 111. Therefore, the home appliance 11 receives the direct-current voltage that is transferred from the first port 102 for operating. The home appliance 11 can be any kind of home appliance, such as a food processor, a blender, a coffee maker, a tea maker, an oven, a microwave oven, an electric fan, an audio system, an iron, a toaster, a rice cooker, a fryer and roasting machine, a dehumidifier, an air purifier, or a vacuum cleaner, etc.

Moreover, the home appliance 11 is replaced by the solar panel 12 that connects to the base 10. In other words, the solar panel 12 is connected to the first port 102 via the third port 121. The solar panel 12 receives solar energy transformed into electrical power, and transfers the electrical power to the first port 102 of the base 10 via the third port 121. Because the recharging circuit 103 is electrically connected to the first port 102 and secondary battery 101, the recharging circuit 103 receives the electrical power from the solar panel 12 to recharge the secondary battery 101.

The control unit 104 is electric coupled with the secondary battery 101 to detect an amount of electricity stored in the secondary battery 101, and controls the display unit 105 to display the amount of electricity stored in the secondary battery 101. The display unit 105 can be any kind of display device or can be displayed by different colors of light emitting diodes (LEDs) to inform a user of the amount of electricity stored in the secondary battery 101.

Because the home appliance 11 can be any kind of household appliance, it requires different voltages to operate. Therefore, the operating unit 106 of the base 10 can be operated by a user to change the quantity of the direct-current voltage of the secondary battery 101 via the controlling unit 104. The voltage of the secondary battery 101 will correspond to the voltage needed by the home appliance 11 being used by the user. The operating unit 106 can be a button or knob so that a user can adjust the voltage of the secondary battery 101.

The present invention receives solar energy to recharge the secondary battery. However, some environments do not have enough solar energy for recharging. For resolving this problem, the base 10 further includes a power input port 107 electrically coupled to the recharging circuit 103 and being capable of receiving a utility power 200. Therefore, the amount of electricity stored in the secondary battery 101 can be recharged any time from the recharging circuit 103.

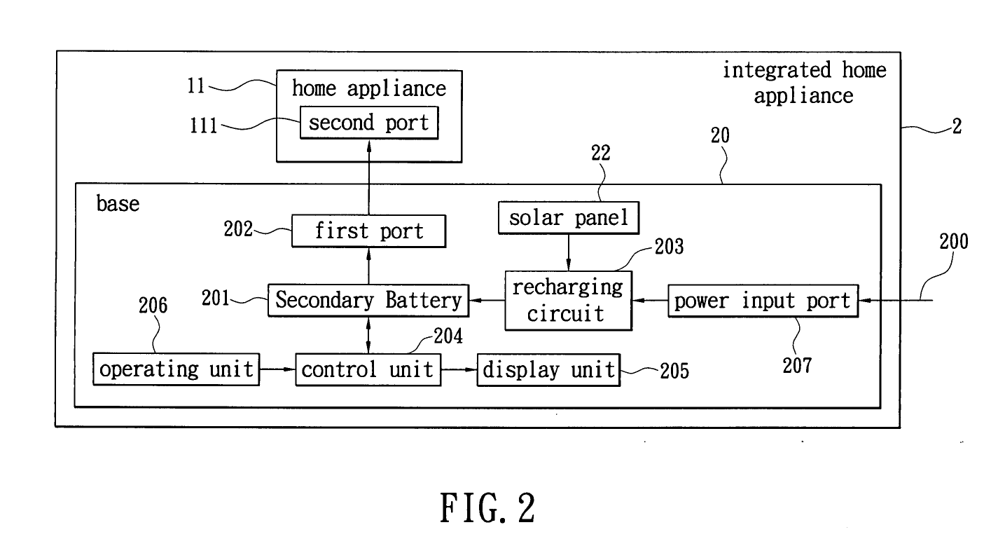

Please refer to FIG. 2, which shows the second embodiment of an integrated home appliance of the present invention. An integrated home appliance 2 includes a base 20, a home appliance 11. The base 20 includes a secondary battery 201, a first port 202, a recharging circuit 203, a control unit 204, a display unit 205, an operating unit 206, a power input port 207, and a solar panel 22. In this embodiment, the structure, operation, and functions of the integrated home appliance 2 are similar to the integrated home appliance 1. The main difference of the integrated home appliance 2 is described below. The solar panel 12 of the first embodiment can be detachably connected to the base 10 by replacing the home appliance 11. The solar panel 22 of the second embodiment is directly disposed on the surface of the base 20. Therefore, the solar panel 22 can receive solar energy all the time without being replaced by the home appliance 11. The first port 202 is connected to the second port 111 of the home appliance 11 to transfer the direct-current voltage to the secondary battery 201 for the home appliance 11. Therefore, the recharging circuit 203 within the base 20 is electrically coupled with the solar panel 22 and the secondary battery 201. The secondary battery 201 can be recharged via the electrical energy supplied by the solar panel 22 at any time.

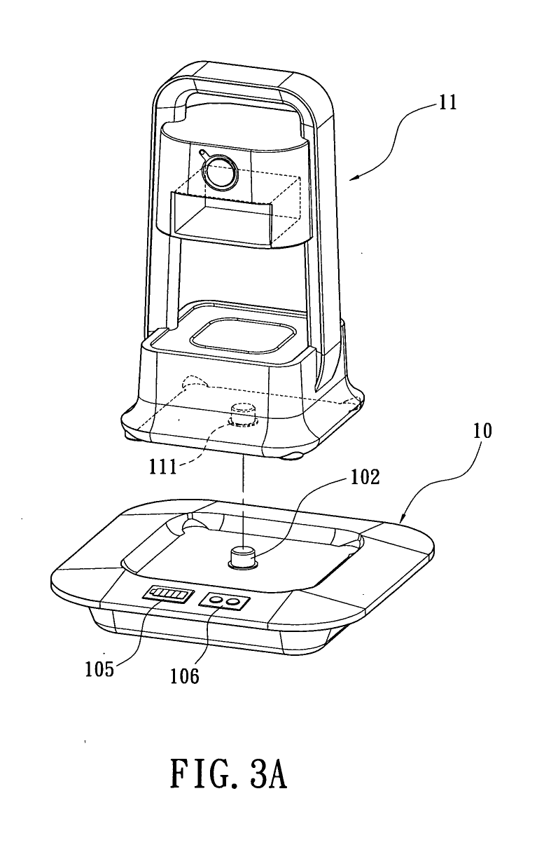

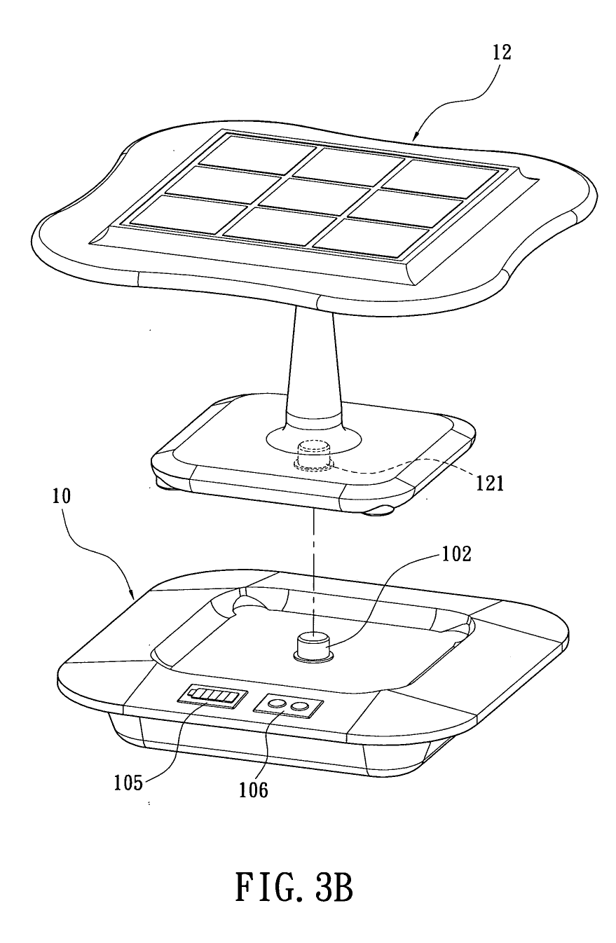

Please refer to FIG. 3A and FIG. 3B, which show the schematic diagram of the application of the integrated home appliance of the first embodiment is using a home appliance or recharging. Please refer to FIG. 3A first. The home appliance 11 can be a coffee machine. The home appliance 11 does not have an electrical cord. The home appliance 11 is connected to the first port 102 via the second port 111 for receiving the electrical power from the secondary battery 101 of the base 10. Because of the weight of the home appliance 11, the home appliance 11 is connected to the base 10 stably. Now please refer to FIG. 3B. The home appliance 11 is replaced by the solar panel 12 to connect to the base 10. The solar panel 12 receives solar energy transformed into electrical energy. The electric energy is transferred to the first port 102 via the third port 121 for recharging the secondary battery 101.

The amount of electricity stored in the secondary battery 101 is displayed on the display unit 105. The operating unit 106 can adjust the voltage of the secondary battery 101 corresponding to the needed voltage of the home appliance 11 being used by the user. The operating unit 106 of this embodiment is a button. The direct-current voltage of the secondary battery 101 is displayed on the display unit 105.

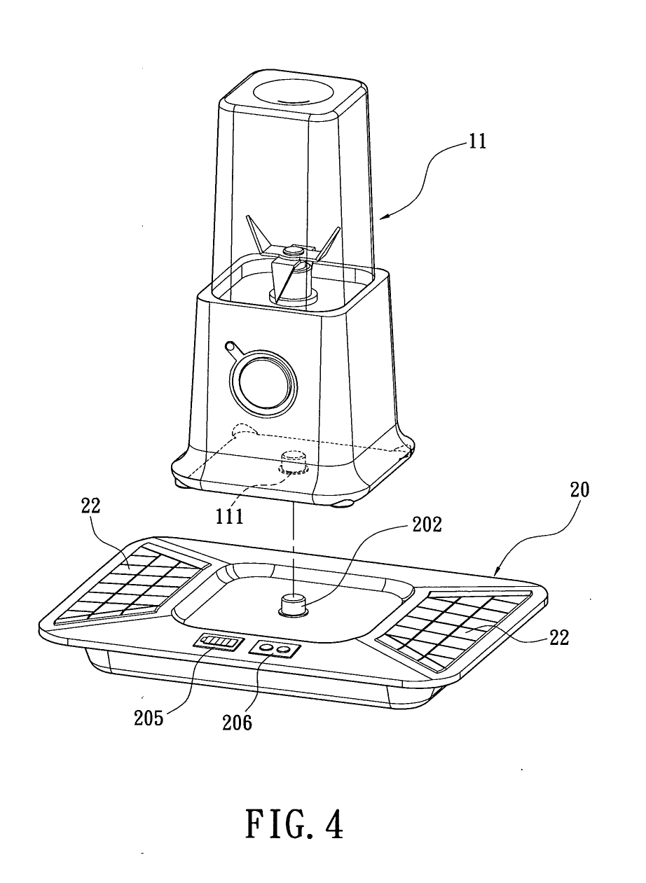

Please refer to FIG. 4, which shows the application of the present invention of the integrated home appliance of the second embodiment. The home appliance 11 is a blender in this embodiment. The solar panel 22 is disposed on the surface of the base 20. The home appliance 11 is connected to the first port 202 of the base 20 via the second port 111 and receives the direct-current voltage provided by the secondary battery 201 of the base 20. Because the solar panel 22 is disposed on the base 20, the solar panel 22 can supply electrical power to the home appliance and recharge the secondary battery 201 at the same time. Similarly, the amount of electricity stored in the secondary battery 201 is displayed on the display unit 205. The operating unit 206 can adjust the voltage of the secondary battery 201 corresponding to the needed voltage of the home appliance 11 being used by a user.

The size and the appearance of the base are not limited by the embodiments. The size ratio between the home appliance and the base in this specification is just used as an example. In practice, if a larger home appliance, such as a microwave oven, is used, the base can be disposed within the bottom of the larger home appliance.

In conclusion, the present invention utilizes the secondary battery to store electrical power transformed from solar energy, and the secondary battery supplies electrical power to home appliance. Therefore, the integrated home appliance of the present invention does not need an external power source. Power cords of traditional home appliances are eliminated, and the appearance of the device is cleaner and simpler. The cost of a home appliance will also be reduced. Moreover, the storage and supply of power uses solar energy, so it causes less environmental damage. Furthermore, a user only needs to buy one base for different kinds of appliances, so the cost to the user is reduced.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. An integrated home appliance, comprising:
a base that further comprises:
a secondary battery used for storing an electrical power and generating a direct-current voltage; and
a first port connected to said secondary battery to transfer said direct-current voltage; and
a home appliance comprising a second port corresponding to said first port detachably connected to said base for receiving said direct-current voltage.

2. The integrated home appliance as claimed in claim 1, wherein said base further comprises:
a recharging circuit electrically connected to said first port and said secondary battery, wherein said first port is used for connecting a solar panel, and said recharging circuit receives said electrical power produced from said solar panel to recharge said secondary battery.

3. The integrated home appliance as claimed in claim 2, further comprising:
a power input port used for receiving an alternating current to recharge said secondary battery.

4. The integrated home appliance as claimed in claim 2, wherein said base further comprises:
a display unit for displaying an amount of electricity stored in said secondary battery; and
a control unit electrically connected to said secondary battery used for detecting said amount of electricity stored in said secondary battery and controlling said display unit to display said amount of electricity stored in said secondary battery.

5. The integrated home appliance as claimed in claim 4, wherein said display unit is a display device or LEDs.

6. The integrated home appliance as claimed in claim 4, further comprising an operating unit electrically connected to said control unit, wherein said operating unit controls a quantity of said direct-current voltage produced from said secondary battery.

7. The integrated home appliance as claimed in claim 6, wherein said operating unit is a button or a knob.

8. The integrated home appliance as claimed in claim 1, wherein said first port protrudes from a surface of said base.

9. The integrated home appliance as claimed in claim 1, wherein said home appliance is an audio system.

10. The integrated home appliance as claimed in claim 1, wherein said home appliance is selected from the group consisting of a food processor, a blender, a coffee maker, a tea maker, an oven, a microwave oven, an electric fan, an audio system, an iron, a toaster, a rice cooker, a fryer and roasting machine, a dehumidifier, an air purifier and a vacuum cleaner.

11. An integrated home appliance, comprising:
a base further comprising:
a solar panel disposed on a surface of said base used for receiving solar energy transformed into an electrical power;
a secondary battery used for storing said electrical power and generating a direct-current voltage;
a first port connected to said secondary battery to transfer said direct-current voltage; and a home appliance comprising a second port corresponding to said first port detachably connected to said base for receiving said direct-current voltage.

12. The integrated home appliance as claimed in claim 11, wherein said base further comprises:
a recharging circuit electrically connected to said solar panel and said secondary battery, and said recharging circuit receives said electrical power from said solar panel and recharges said secondary battery.

13. The integrated home appliance as claimed in claim 12, further comprising a power input port for receiving an alternating current to recharge said secondary battery.

14. The integrated home appliance as claimed in claim 12, wherein said base further comprises:
a display unit for displaying an amount of electricity stored in said secondary battery; and
a control unit electrically connected to said secondary battery for detecting said amount of electricity stored in said secondary battery and controlling said display unit to display said amount of electricity stored in said secondary battery.

15. The integrated home appliance as claimed in claim 14, wherein said display unit is a display device or LEDs.

16. The integrated home appliance as claimed in claim 14, further comprising an operating unit electrically connected to said control unit, wherein said operating unit controls a quantity of said direct-current voltage produced from said secondary battery.

17. The integrated home appliance as claimed in claim 16, wherein said operating unit is a button or a knob.

18. The integrated home appliance as claimed in claim 11, wherein said first port protrudes from a surface of said base.

19. The integrated home appliance as claimed in claim 11, wherein said home appliance is an audio system.

20. The integrated home appliance as claimed in claim 11, wherein said home appliance is selected from the group consisting of a food processor, a blender, a coffee maker, a tea maker, an oven, a microwave oven, an electric fan, an audio system, an iron, a toaster, a rice cooker, a fryer and roasting machine, a dehumidifier, an air purifier and a vacuum cleaner.
